(19) United States
(12) Patent Application Publication
(10) Pub. No.: US 2013/0106679 A1
(43) Pub. Date: May 2, 2013

(54) LCD PANEL AND METHOD OF MANUFACTURING THE SAME

(71) Applicant: Hung-jui Chen, Shenzhen (CN)

(72) Inventor: Hung-jui Chen, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/379,568

(22) PCT Filed: Nov. 7, 2011
(86) PCT No.: PCT/CN2011/081845

§ 371 Date: Dec. 20, 2011

(30) Foreign Application Priority Data
Nov. 2, 2011 (CN) 201110341153.9

(51) Int. Cl. G09G 3/36; H01J 9/00

(52) U.S. Cl. 345/92; 445/24

(57) ABSTRACT

A liquid crystal display (LCD) panel and a method of manufacturing the same are proposed. In addition to an insulating layer disposed between data lines and scan lines, an amorphous silicon (a-Si) layer is disposed between the insulating layer and the data lines to improve the insulation, thereby reducing current leakage on the crossovers of the data lines and the scan lines. The above-mentioned structure can be formed without conducting additional mask processes. As a result, current leakage between the data lines and the scan lines can be affectively reduced without additional costs using the LCD panel and the method of manufacturing the same proposed by the present invention.

### BACKGROUND OF THE INVENTION

1. Field of the Invention

The present invention relates to a liquid crystal display (LCD) panel and a method of manufacturing the same, and more particularly, to an LCD panel and a method of manufacturing the same in which an amorphous silicon (a-Si) layer is disposed on the crossovers of data lines and scan lines to improve the insulation, thereby preventing current leakage from the data lines and the scan lines.

2. Description of Prior Art

A conventional LCD panel comprises a plurality of pixels. Each of the plurality of pixels is sub-divided into three sub-pixels colored red, green, and blue (RGB). A gate driver outputs a scan signal through a scan line to activate the thin-film transistor (TFT) on each pixel in each row to be turned on in order. Meanwhile, a source driver outputs a corresponding data signal to the TFT through a data line. The data signal passes through the TFT and is transmitted to a pixel electrode so that each of the components obtains its required voltage at full charge to display different grayscales. The gate driver outputs the scan signal row by row to turn on the TFT on the pixel in each row. Then, the source driver charges/discharges the pixel electrode in each row. Depending upon this sequence, an image will be completely shown on the LCD panel.

An insulating layer is usually disposed on the crossover of a data line and a scan line to break an electrical connection between the data line and the scan line in the conventional manufacturing processes of LCD panels. However, insulating layers are inclined to have poor insulation, causing current leakage to occur frequently between data lines and scan lines. Thus, signals cannot be transmitted stably through data lines and scan lines, affecting display effects of LCD panels.

Therefore, a solution needs to be proposed to improve the performance of LCD panels.

### SUMMARY OF THE INVENTION

It is therefore an object of the present invention to provide an LCD panel and a method of manufacturing the same. In addition to an insulating layer disposed between data lines and scan lines in the crossovers formed by the data lines and the scan lines, an a-Si layer is disposed between the insulating layer and the data lines to improve the insulation of the data lines and the scan lines, thereby reducing current leakage.

According to the present invention, the present invention proposes a liquid crystal display (LCD) panel. The LCD panel comprises a glass substrate and a thin-film transistor (TFT) comprising a gate, a source, and a drain. The LCD panel further comprises: a scan line, disposed on the glass substrate and coupled to the gate of the TFT; an insulating layer, disposed on the scan line; a data line, disposed on the insulating layer and coupled to the source of the TFT wherein a crossover is produced after the data line and the scan line are intercrossed; and a semiconductor layer, disposed between the gate insulating layer and the data line, corresponding to the crossover, and being larger in area than the crossover for improving the insulation of the data line and the scan line using the semiconductor layer.

According to the present invention, the present invention further proposes a method of manufacturing an LCD panel. The method comprises: providing a glass substrate; forming a first metal layer on the glass substrate; etching the first metal layer to form a gate of a thin film transistor and a scan line; forming an insulating layer on the gate of the thin film transistor and the scan line; forming a semiconductor layer on the insulating layer; etching the semiconductor layer to form a channel of the thin film transistor and a first region; forming a second metal layer and etching the second metal layer to form a source and a adrain of the thin film transistor and a data line, wherein a crossover is produced after the data line and the scan line are intercrossed, the crossover corresponds to first region, and the first region is larger in area than the crossover.

According to the present invention, the semiconductor layer is an N+ a-Si layer with high electron doping concentrations.

According to the present invention, a distance between an edge of the a-Si layer and an edge of the crossover is greater than 1.5 μm.

In contrast to the conventional technology, in addition to a gate insulating layer used for insulating data lines and scan lines in the present invention, an a-Si layer is disposed between the gate insulating layer and the data lines to improve the insulation of the data lines and the scan lines, thereby reducing current leakage. And the above-mentioned structure can be formed without conducting additional mask processes. Therefore, current leakage between the data lines and the scan lines can be effectively reduced without additional costs using the LCD panel and the method of manufacturing the same proposed by the present invention.

These and other features, aspects and advantages of the present disclosure will become understood with reference to the following description, appended claims and accompanying figures.

### BRIEF DESCRIPTION OF THE DRAWINGS

FIG. 1 shows a simplified schematic diagram of an LCD panel according to a preferred embodiment of the present invention.

FIGS. 2-6 illustrate schematic diagrams of the manufacturing processes of the LCD panel according to the present invention.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

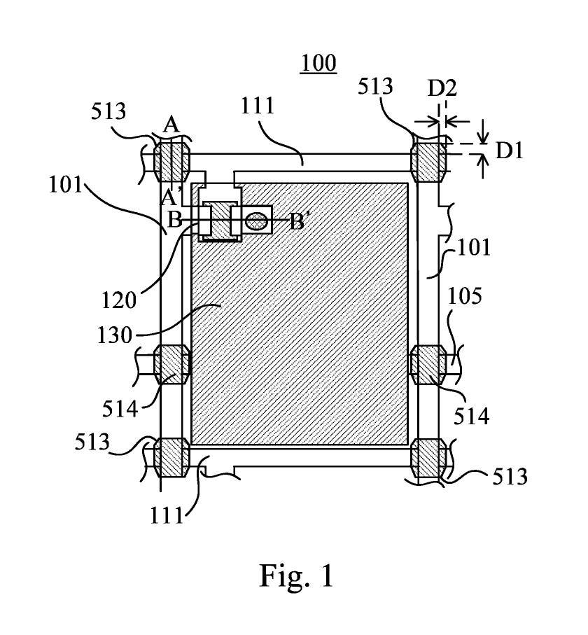

Referring to FIG. 1 showing a simplified schematic diagram of an LCD panel 100 according to a preferred embodiment of the present invention. The LCD panel 100 comprises a plurality of data lines, a plurality of scan lines, a plurality of common lines, a plurality of TFTs, and a plurality of pixel electrodes. Each of the TFTs is electrically connected to a scan line and a data line. For simplicity, a data line 101, a scan line 111, a common line 105, and a TFT 120 are shown in this embodiment. The scan line 111 is coupled to the gate of the TFT 120. The data line 101 is coupled to the source of the TFT 120. The drain of the TFT 120 is coupled to a pixel electrode 130. The common line 105 is used for transmitting a common voltage signal.

The method of driving the LCD panel 100 is as follows: A scan signal output by a gate driver is transmitted to the TFT 120 through the scan line 111, causing the TFT 120 disposed on the scan line 111 to be turned on in order. Meanwhile, a corresponding data signal output by a source driver is transmitted to the TFT 120 through the data line 101. Then, the data signal passes through the TFT 120 and is transmitted to the pixel electrode 130 so that each of the components obtains its required voltage at full charge. The LCs on the pixel electrode 130 twist depending upon the voltage difference between the data signal and the common voltage signal transmitted through the common line 105 to display different grayscales. The gate driver outputs the scan signal row by row through the plurality of scan lines to turn on the TFT 120 in each row. Then, the source driver charges/discharges the pixel electrode 130 in each row. Depending upon this sequence, an image will be completely shown on the LCD panel 100.

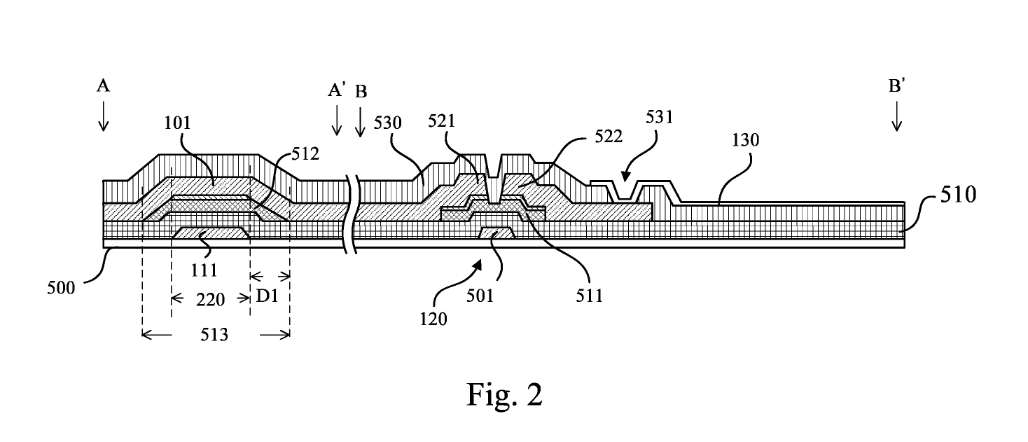

Please refer to FIG. 1 and FIG. 2 illustrating a structure diagram of the LCD panel 100 shown in FIG. 1. FIG. 2 is also a cross section view of the LCD panel 100 taken along line A-A′ and B-B′ of FIG. 1. In addition to an insulating layer 510 disposed on a crossover 220 of the data line 101 and the scan line 111, a semiconductor layer 512 is disposed between the insulating layer 510 and the data line 101. A first region 513 on which the semiconductor layer 512 is disposed is larger in area than the crossover 220. The data line 101 can be successfully separated from the scan line 111 by the semiconductor layer 512, preventing current leakage occurring between the data line 101 and the scan line 111.

The first region 513 is larger in area than the crossover 220. Take the first region 513 at right upper corner of FIG. 1 as an example, an edge of the crossover 220 is far from that of the first region 513 by a distance D1 in exceed of 1.5 μm, and another edge of the crossover 220 is far from the data line 101 by a distance D2 of 1.5 μm. In order to separate the scan line 111 from the data line 101 by the semiconductor layer 512 of the first region 513, the first region 513 must be larger in area than the crossover 220. Preferably, a distance from the the scan line 111 or the data line 101 to one edge of the first region 513 is over 1.5 μm based on tests, so that current leakage can be effectively reduced.

The manufacturing processes of the LCD panel 100 of the present invention will be disclosed as follows.

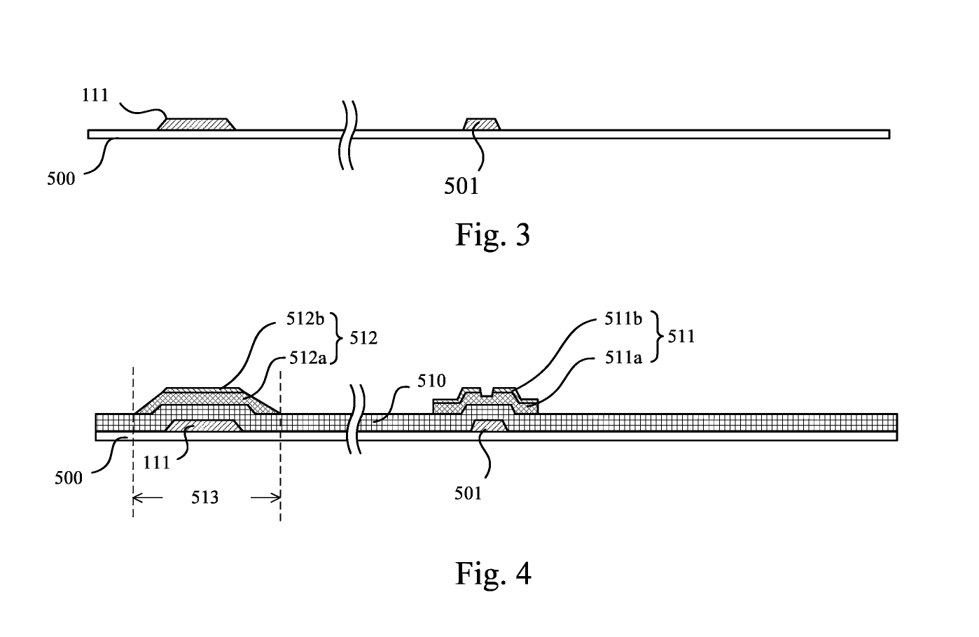

Referring to FIG. 3, a glass substrate 500 serves as a bottom substrate. A metal thin-film deposition is conducted on the glass substrate 500 to form a first metal layer (not shown) on the surface of the glass substrate 500. Also, a first photo etching process (PEP) is conducted using a first mask to form a gate 501 of the TFT 120 and the scan line 111.

Referring to FIG. 4, an insulating layer 510 made of silicon nitride (SiNx) is deposited and covers the gate 501 and the scan line 111. An a-Si (Amorphous Silicon) layer and an N+ a-Si layer with high dopant doping concentrations are deposited on the insulating layer 510 consecutively. Two semiconductor layers 511 and 512 are formed after a second PEP is conducted using a second mask. The semiconductor layer 511 comprises an a-Si layer 511a and an ohmic contact layer 511b. The a-Si layer 511a serves as a channel of the TFT 120. The ohmic contact layer 511b is used for reducing resistance. The semiconductor layer 512 comprises an a-Si layer 512a and an N+ a-Si layer 512b. The semiconductor layer 512 is disposed on the first region 513 and has a function of assisting the insulating layer 510 to improve the insulation of the data line 101 and the scan line 111, as mentioned above.

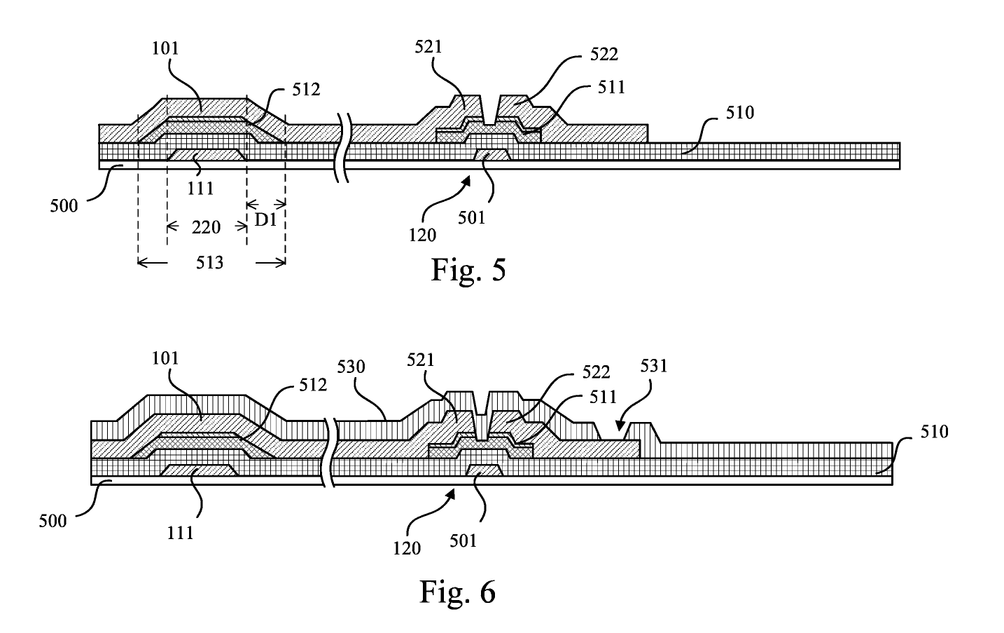

Referring to FIG. 5, a second metal layer (not shown) is formed on the insulating layer 510 and covers the insulating layer 510 completely. A source 521 of the TFT 120, a drain 522 of the TFT 120, and the data line 101 are respectively defined after a third PEP is conducted using a third mask. As shown in FIG. 5, the data line 101 and the scan line 111 are intercrossed, producing a crossover 220. The crossover 220 is smaller in area than the first region 513. Preferably, the first region 513 is broader than the data line 101 (or the scan line 111). The distance D2 (or the distance D1) between the edge of the first region 513 and the edge of the data line 101 (the scan line 111) at the same side is 1.5 μm.

Referring to FIG. 6, a passivation layer 530 made of SiNx is deposited and covers the source 521, the drain 522, and the insulating layer 510. Next, a fourth PEP is conducted using a fourth mask to remove part of the passivation layer 530 on the drain 522 until the surface of the drain 522 is exposed. A via 531 is formed on the drain 522.

Please refer to FIG. 2 again. FIG. 2 is a cross section view of the LCD panel 100 taken along line A-A′ of FIG. 1 also shows a structure diagram of the first region 513 and the TFT 120 as shown in FIG. 1. A transparent conducting layer made of indium tin oxide (ITO) is formed on the passivation layer 530. Next, another transparent conducting layer 130 is formed after the transparent conducting layer is etched using a fifth mask. The transparent conducting layer 130 is electrically connected to the drain 522 of the TFT 120 and connected to a pixel capacitor via the via 531 formed beforehand. The transparent conducting layer 130 serves as a pixel electrode. At last, the LCD panel 100 is completely done at this stage.

As shown in FIG. 2, the gate 501 is formed by a first metal layer, and the source 521 and the drain 522 is formed by a second metal layer. The channel of the TFT 120 is formed by an a-Si layer 511.

In addition, the scan line 111 is formed by the first metal layer. A scan signal output by the gate driver is transmitted through the scan line 111. The data line 101 is formed by the second metal layer. A data signal output by the source driver is transmitted through the data line 101.

It is notified that, in the present invention the semiconductor layer 512 is also disposed between the scan line 111 and the data line 101 in addition to the insulating layer 510 which is commonly disposed in a conventional LCD panel. The use of the semiconductor layer 512 has two benefits: the distance between the scan line 111 and the data line 101 becomes longer, and the insulation between the scan line 111 and the data line 101 is improved, preventing current leakage occurring between the data line 101 and the scan line 111.

Furthermore, the semiconductor layer 512 has to be larger in area than the crossover 220 formed by the scan line 111 and the data line 101. As shown in FIG. 2, the first region 513 on which the semiconductor layer 512 is disposed is larger in area than the crossover 220. The distance between any two edges of the first region 513 and the crossover 220 at the same side is around 1.5 μm. Thus, the data line 101 can be successfully separated from the scan line 111 by the semiconductor layer 512, preventing current leakage occurring between the data line 101 and the scan line 111.

It is notified that, although the processes for depositing and photo etching the a-Si layer exist in the manufacturing processes of conventional LCD screens, the a-Si layer just serves as a channel of the TFT 120. In the present invention the a-Si layer is formed on the first region 513 by using conventional original five mask processes without adding an extra mask process. So the distance between the data line 101 and the scan line 111 is successfully increased without additional costs and additional mask processes. Owing to the increased distance, the insulation of the data line 101 and the scan line 111 is improved, which prevents current leakage occurring between the data line 101 and the scan line 111.

Continuing to refer to FIG. 1, the a-Si layer 512 added in the present invention is to prevent current leakage occurring between the data line 101 and the scan line 111. Actually, such an application is not to limit the present invention. In practical application, both of the common line 105 and the scan line 111 are made of the first metal layer. Also, the common line 105 is intercrossed with the data lines 101. So it is possible to dispose the semiconductor layer 512 between the common line 105 and the data lines 101. That is, two second regions 514 covered by the semiconductor layer 512 roughly coincide with the crossovers formed by the data lines 101 and the common line 105. So the semiconductor layer 512 can improve the insulation of the common line 105 and the data lines 101 as well. Any equivalent modification and variation according to the spirit of the present invention is to be also included within the scope the present invention.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A liquid crystal display (LCD) panel, comprising a glass substrate and a thin-film transistor (TFT) comprising a gate, a source, and a drain, characterized in that: the LCD panel further comprises:
a scan line, disposed on the glass substrate and coupled to the gate of the TFT;
an insulating layer, disposed on the scan line;
a data line, disposed on the insulating layer and coupled to the source of the TFT wherein a crossover is produced after the data line and the scan line are intercrossed; and
a semiconductor layer, disposed between the gate insulating layer and the data line, corresponding to the crossover, and being larger in area than the crossover for improving the insulation of the data line and the scan line using the semiconductor layer.

2. The LCD panel of claim 1, characterized in that: the semiconductor layer is an amorphous silicon (a-Si) layer.

3. The LCD panel of claim 2, characterized in that: a distance between an edge of the a-Si layer and an edge of the crossover is greater than 1.5 μm.

4. The LCD panel of claim 2, characterized in that: the semiconductor layer is an N+ a-Si layer with high electron doping concentrations.

5. A liquid crystal display (LCD) panel, comprising a glass substrate and a thin-film transistor (TFT) comprising a gate, a source, and a drain, characterized in that: the LCD panel further comprises:
a common line, disposed on the glass substrate for supplying a common voltage to the LCD panel;
an insulating layer, disposed on the common line;
a data line, disposed on the insulating layer and coupled to the source of the TFT wherein a crossover is produced after the data line and the common line are intercrossed; and
a semiconductor layer, disposed between the gate insulating layer and the data line, corresponding to the crossover, and being larger in area than the crossover for improving the insulation of the data line and the common line using the semiconductor layer.

6. The LCD panel of claim 5, characterized in that: the semiconductor layer is an amorphous silicon (a-Si) layer.

7. The LCD panel of claim 6, characterized in that: the semiconductor layer is an N+ a-Si layer with high electron doping concentrations.

8. The LCD panel of claim 6, characterized in that: a distance between an edge of the a-Si layer and an edge of the crossover is greater than 1.5 μm.

9. A method of manufacturing an LCD panel, characterized in that: the method comprises:
providing a glass substrate;
forming a first metal layer on the glass substrate;
etching the first metal layer to form a gate of a thin film transistor and a scan line;
forming an insulating layer on the gate of the thin film transistor and the scan line;
forming a semiconductor layer on the insulating layer;
etching the semiconductor layer to form a channel of the thin film transistor and a first region;
forming a second metal layer and etching the second metal layer to form a source and a adrain of the thin film transistor and a data line, wherein a crossover is produced after the data line and the scan line are intercrossed, the crossover corresponds to first region, and the first region is larger in area than the crossover.

10. The method of claim 9, characterized in that: the semiconductor layer is an amorphous silicon (a-Si) layer.

11. The method of claim 10, characterized in that: a distance between an edge of the first region and an edge of the crossover is greater than 1.5 μm.
